(19) United States
(12) Patent Application Publication
(10) Pub. No.: US 2017/0069439 A1
(43) Pub. Date: Mar. 9, 2017

(54) POSITION INDICATOR

(71) Applicant: Maschinenfabrik Reinhausen GmbH, Regensburg (DE)

(72) Inventor: Silke WREDE, Zeitlarn (DE)

(21) Appl. No.: 15/122,645

(22) PCT Filed: Apr. 27, 2015
(86) PCT No.: PCT/EP2015/059059

§ 371 Date: Aug. 31, 2016

(30) Foreign Application Priority Data
May 8, 2014 (DE) 10 2014 106 475.5

(51) Int. Cl. H01H 9/00

(52) U.S. Cl. CPC H01H 9/0033; H01H 2235/01; H01H 2219/028

(57) ABSTRACT

A position indicator for a tap changer of a tapped transformer comprises
a display device (51) for displaying the current switch position of the tap changer, which display device (51) is stepped with each switchover and which comprises first and second display disks (21, 26);
an indicator gear (10) that is coupled to the two display disks (21, 26) for driving them in a switch-direction-dependent manner and which can be coupled to a switching shaft of the tap changer;
wherein
each display disk (21, 26) comprises sets of numbers in an angularly extending or circular row;
with each step one number of the row of numbers on the first display disk (21) and one number of the row of numbers on the second display disk (26) are positioned side by side such that these numbers represent the current switch position of the tap changer expressed as digits combined to form a multi-digit number.

The present invention relates to a position indicator for a tap changer of a tapped transformer.

For the purpose of changing the transmission ratio of an oil-insulated transformer under load, so-called tap changers or, as the case may be, on-load tap changers are provided, the structure and function of which are in principle known and that are formed for switching the winding taps of a tap winding of a transformer.

Such an on-load tap changer, which is connected to the tap winding, usually has a load diverter switch and a selector, and the selector preferably consists of a preselector and a fine selector. The fine selector is provided for the powerless selection of the winding tap of the tap winding and of the preselectors, which winding tap is to be connected, for the purpose of increasing the regulating range, where, according to application, the preselector can be formed either as change-over selector for the boost and buck connection of the tap winding or as coarse selector for the linkage of the tap winding to the beginning or to the end of the main winding of the transformer.

The load transfer in itself is carried out by the load diverter switch of the on-load tap changer, specifically from the previous to the new, preselected winding tap of the transformer tap winding. For this purpose, the load diverter switch usually has mechanical switch contacts and resistance contacts, where the switch contacts serve for direct connection of the respective winding taps to the load dissipation, and the resistance contacts serve for temporary bridging by one or more transition resistances. The developments of the past years, however, lead away from load diverter switches with mechanical switch contacts and toward using vacuum switching tubes or semiconductor switching components, in particular circuit breaker components, as switching components for high voltages and currents, for example thyristors, GTOs, IGBTs, and other components.

Integrated on-load tap changers, which are also called load selectors, are another genus of on-load tap changers. In these, the load diverter switch and the fine selector are constructed as one unit. Upon actuation, the winding tap to be switched is preselected and subsequently switched in a single step. This form of realization of an on-load tap changer can also have a preselector that is mounted either outside of or inside the housing of the on-load tap changer, specifically in an insulation medium, preferably in insulation oil.

Such tap changers in addition generally have a position indicator by aid of which the present switching position is displayed in the area of the cover closing the load diverter switch by means of a display disk that is coupled with the drive of the selector via a transmission gear. While the selector, which is subject to practically no wear, remains unaffected, the load diverter switch has to be removed at certain intervals for inspection purposes. As a result, it is necessary to take technical precautions for the position indicator to prevent the display from being readjusted in relation to the present switching position of the tap changer during inspection works. This is particularly difficult if the position indicator is directly tapped from the selector, which has to be done, in particular, in the instance of the transmission for the selector being mounted between load diverter switch and selector.

The number of potential switching positions varies greatly depending on the division of the fine selector and also of the preselector. The position indicator therefore has to be able to offer up to over 100 switching positions. In the position indicators as known from the prior art, the amount of numbers to be accommodated on the display disk is, however, essentially limited by the diameter of the display disk as well as by the fact that the switching angle of the transmission gear and the digits for the display cannot be realized in an arbitrarily small size.

The object of the invention is to specify a position indicator for a tap changer of a tapped transformer, which position indicator eliminates the previously mentioned disadvantages.

This object is fulfilled by a position indicator according to the independent claim. Advantageous developments and embodiments of the invention are described in the dependent claims.

The invention proposes a position indicator comprising
a display device for displaying the current switch position of the tap changer, which display device is stepped with each switchover and which comprises first and second display disks;
an indicator gear that is coupled to the two display disks for driving them in a switch-direction-dependent manner and which can be coupled to a switching shaft of the tap changer;

where
each display disk has an angularly extending or circular row of numbers;
with each step one number of the row of numbers on the first display disk and one number of the row of numbers on the second display disk are positioned side by side such that these numbers express the current switch position of the tap changer as individual digits combined to form a multi-digit number.

The invention is based on the knowledge that more than 100 different switching positions of the tap changer can be specified in an easy and compact way by the specific arrangement of numbers on the display disks in the interaction with the indicator gear, as a potential switching position can be expressed as a combined multi-digit number by the first display disk expressing the ones digit and by the second display disk expressing the tens digit. Each switchover thus causes the first display disk to rotate by the indicator gear by a definable circle sector of preferably 36 degrees such that the next ones digit of the first display disk comes to be positioned opposite to the expressed tens digit in the tangential area of the display disks. When the ones digit 9 is swept over to 0, the second display disk comes into engagement by the indicator gear via the mechanical coupling such that in said switchover, the tens digit is also changed in descending order or, as the case may be, in ascending order, by one digit, that is, from 0 to 1, or alternatively from 1 to 0, for example. In this way, it is possible for the switching position 09 to be changed over to 10 or, as the case may be, for the switching position 10 to be changed over to 09 to be expressed by a combined multi-digit number.

It can be provided that
the indicator gear is formed as stepping gear and comprises a drive wheel and a driven wheel.

It can be provided that
the indicator gear is formed as a Geneva drive;
the drive wheel has a Geneva driver or entraining component;
the driven wheel is formed as a Geneva wheel that interacts with and/or interacts with the Geneva driver.

The Geneva driver is preferentially mounted on a top side of the drive wheel and can support a roller component. The Geneva wheel is preferentially mounted on a top side of the driven wheel.

It can be provided that
the drive wheel has a blocking disk;
the driven wheel has a blocking cam that interacts with and/or interacts with the blocking disk (14.2).

Preferentially, the blocking disk is mounted under the Geneva driver and the blocking cam is mounted under the Geneva wheel.

It can be provided that
the first display disk is coupled to the drive wheel via a first pivot pin; and/or
the second display disk is coupled to the driven wheel via a second pivot pin.

It can be provided that
the row of numbers of the first display disk comprises the numbers 0 to 9; and/or
the row of numbers of the second display disk comprises the numbers 0 to 10.

Each row of numbers can be formed in any manner as required and can comprise a different amount of numbers and/or different numbers, for example.

It can be provided that each of the proposed position indicators comprises
a base plate on which the display device and the indicator gear are mounted such that the position indicator forms a pre-assembled or pre-assemblable module that can be detachably installed or detachably mounted or detachably fastened to the oil vessel of the tap changer.

This has the advantage that no individual components have to be separately de-installed for maintenance purposes, but that it is rather possible to remove or de-install or, as the case may be, put in or install the entire position indicator as one module.

It can be provided that each of the proposed position indicators comprises
a blocking device that is formed such that it releases the indicator gear when the position indicator is installed, and blocks the indicator gear when the position indicator is detached.

It can be provided that
the drive wheel has first gear teeth;
the driven wheel has second gear teeth;
the blocking device comprises a first pawl that interacts with and/or interacts with the first gear teeth, can engage into them, and is mounted on the base plate; a second pawl that interacts with and/or interacts with the second gear teeth, can engage into them, and is mounted on the base plate; and a compression spring that is braced against the pawls and urges them into the blocked position.

Preferably, the first gear teeth are mounted at the bottom side of the drive wheel, and the second gear teeth are mounted at the bottom side of the driven wheel.

It can be provided that
each pawl has a bore;
in the release position of the blocking device the bores are aligned with each other, and in the blocked position of the blocking device the bores are not aligned with each other;
with the position indicator being installed, the bores are both slipped over or can be slipped over a pin that is mounted on the oil vessel.

It can be provided that
the individual components of the position indicator are produced using a plastic and/or a polymer and/or a glass-fiber reinforced plastic.

It can be provided that each of the proposed position indicators comprises
extensions between the pivot pins and the respective display disks.

In this instance, it is particularly advantageous for the display disks to be mounted outside of a cover of the tap changer.

In the following, embodiments of the invention are explained in detail by the attached drawings. The individual features thereof are, however, not limited to the individual embodiments but can be connected and/or combined with individual features described further above and/or with individual features of other embodiments. Each example in the illustrations is provided by way of explanation, not limitation of the invention. The reference characters included in the claims are by no means intended to limit the scope of protection, but rather merely refer to the embodiments shown in the figures, in which

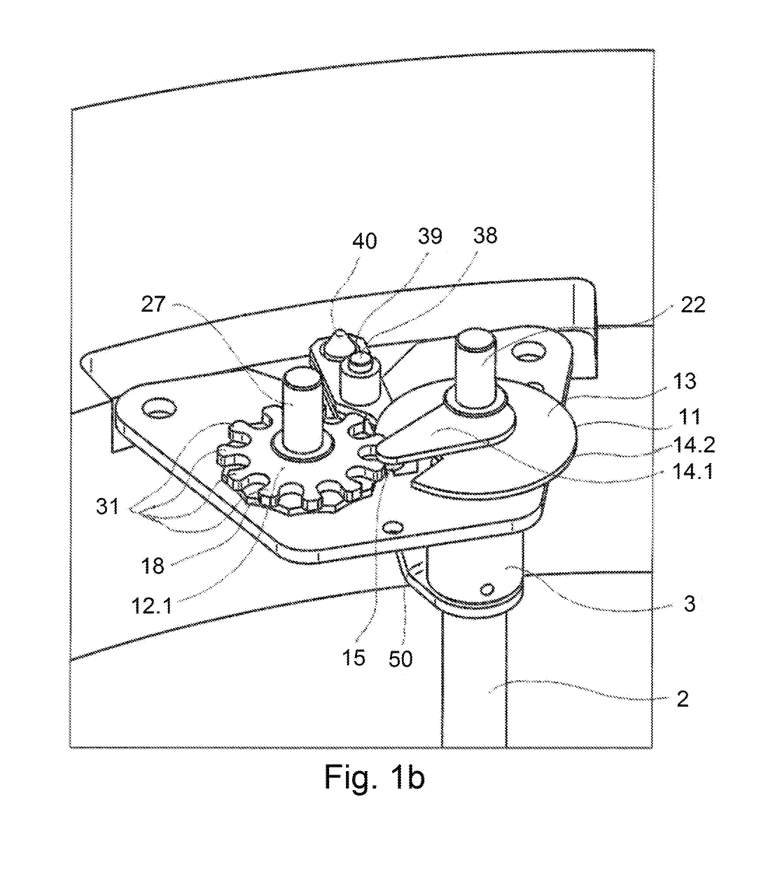

FIG. 2a, b are perspective side views of a first embodiment of a position indicator;

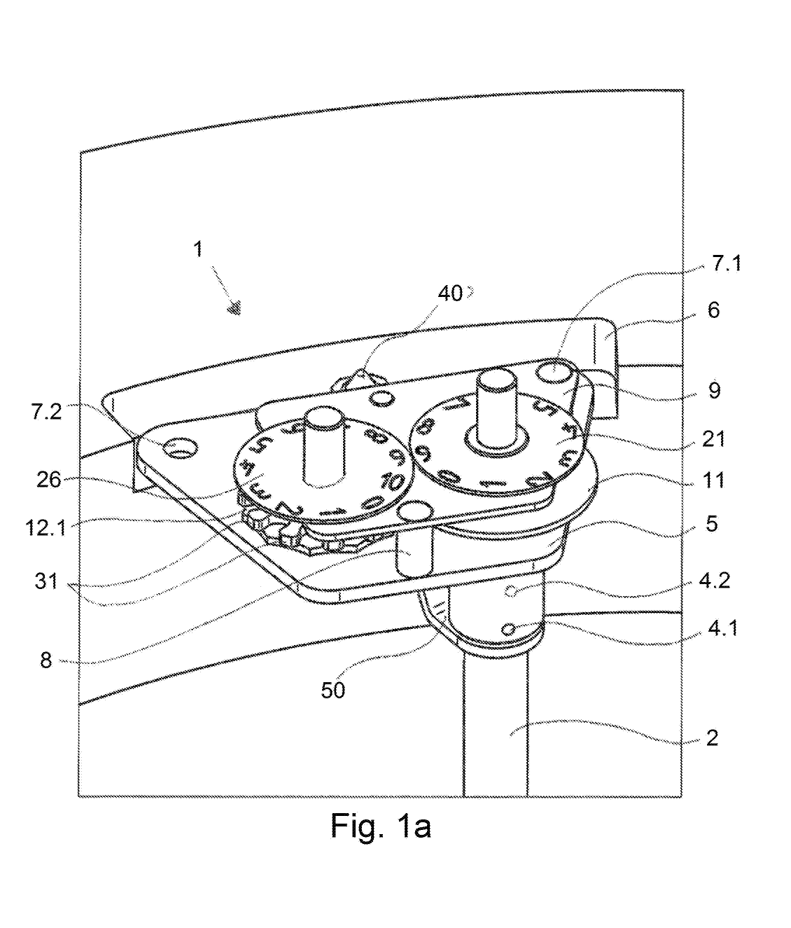

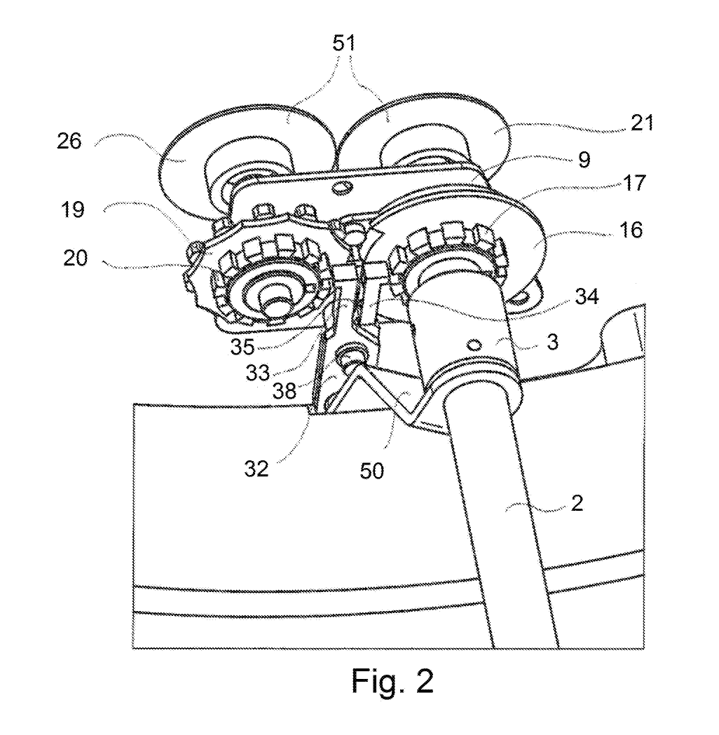

FIG. 3 is a further perspective side view of the position indicator of FIG. 1;

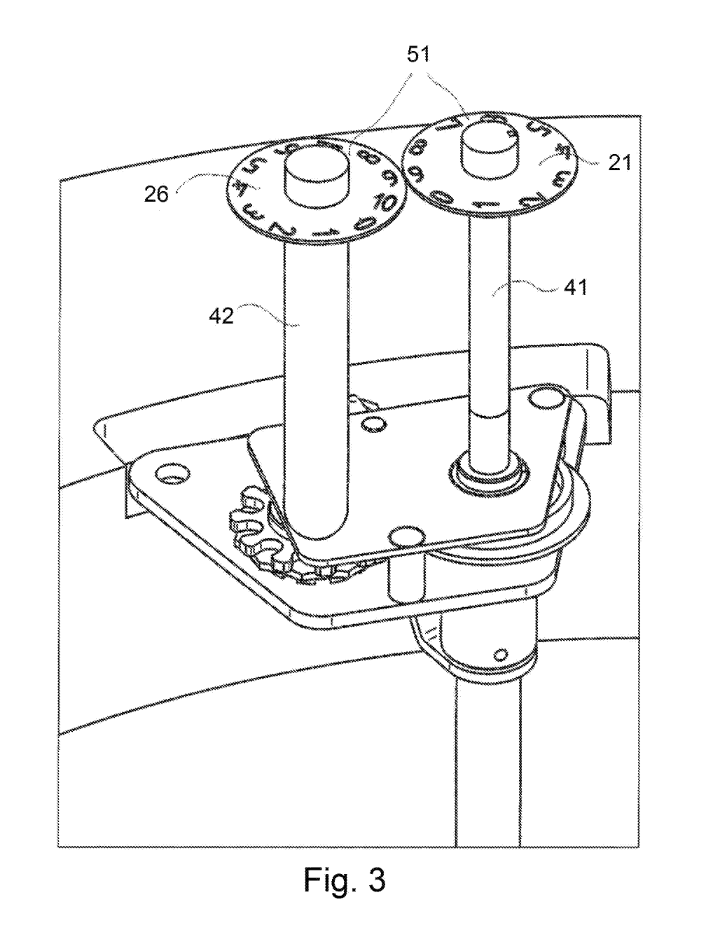

FIG. 4 is a perspective side view of a second embodiment of the position indicator.

FIGS. 1a and 1b schematically illustrate a first embodiment of a position indicator 1. For the purpose of clarity, only components that are essential to the function of the position indicator 1 are illustrated and described. Such position indicators 1 are employed, in particular, for displaying the present switching position of a tap changer that is not illustrated in further detail here. According to genus, tap changers have a switching shaft and, mounted in the bottom area of an oil vessel, a position indicator gear as is known, for example, from DE 81 04 864 U1, from DE 71 34 013, or from DE 34 21 346 C2. Text passages regarding the mechanical coupling of the position indicator gear with the switching shaft of the tap changer, as well as the mentioned modules in themselves, are included by reference as if fully set forth herein.

In this embodiment, the position indicator 1 comprises a display device 51, an indicator gear 10 and a base plate 5.

Movement tapping of the position indicator gear of the tap changer is thus carried out via an indicator shaft 2. At the top end, meaning the end facing toward the position indicator 1, a bushing 3 is, for example, slipped over the indicator shaft 2 and mechanically fastened to the indicator shaft 2 by fixing components 4.1 and 4.2, in particular by pins or screws. The position indicator 1 moreover has a supporting base plate 5 by means of which the position indicator 1 can be mounted together with a support arm 50 on an area of an oil vessel 6 of the tap changer, which oil vessel 6 is only illustrated in extracts here. For this purpose, the base plate 5 has bores 7.1 and 7.2 for being screwed to a recess provided in the oil vessel 6, for example. Provided at the base plate 5, there is moreover a plurality of spacers 8 that hold a further plate 9 spaced apart from the base plate 5.

An indicator gear 10 with a drive wheel 11 and a driven wheel 12 is positioned between the base plate 5 and the further plate 9. Particularly preferentially, the indicator gear 10 is a stepping gear, in particular a Geneva drive. At a top side 13, the drive wheel 11 for this purpose has a Geneva driver 14.1 that can only be seen in FIG. 1b and which as a roller component 15 and a blocking disk 14.2 mounted thereat, and the blocking disk 14.2 has a recess in the area of the Geneva driver 14.1 in the disk segment of the blocking disk 14.2. Provided at a bottom side 16, which cannot be seen here, are gear teeth 17 that can also not be seen in this illustration. In this context, the Geneva driver 14.1 and the blocking disk 14.2 are non-rotatably in operative connection with the indicator shaft 2 by a first pivot pin 22. The traction required for this is explained in detail below.

The driven wheel 12 here takes the form of a Geneva wheel 12.1, in particular a Geneva star wheel, with a plurality of engagement components 31 and a blocking cam 18. The driven wheel 12 is then also non-rotatably connected by a second pivot pin 27. Moreover, the driven wheel 12 also comprises gear teeth 20 at its bottom side 19 that is not illustrated in FIG. lb. How the individual components engage into each other during a switchover and mutually influence each other is explained in detail further below.

Mechanically coupled with the drive wheel 11 is a first display disk 21 that rotates together with the drive wheel 11 when it performs a rotation. Arranged in a circle on the first display disk 21 is moreover a first row of numbers 0 to 9. The mentioned mechanical coupling between drive wheel 11 and first display disk 21 can be particularly preferentially realized by a first pivot pin 22 that has a keyway at each of its oppositely located ends, which keyway at the one end is in operative connection with a first keyway corresponding to the drive wheel 11, and at its other end with a second keyway provided in the display disk 21 and with a key that is insertable into a respective keyway, however not illustrated in detail here.

Mechanically coupled with the driven wheel 12, on the other hand, is a second display disk 26 that rotates together with the driven wheel 12 when the latter performs a rotation. Arranged in a circle on the second display disk 26 is moreover a second row of numbers 0 to 10. The mentioned mechanical coupling between driven wheel 12 and second display disk 26 can be particularly preferentially realized by a second pivot pin 27 that has a keyway at each of its oppositely located ends, which keyway at the one end is in operative connection with a first keyway corresponding to the driven wheel 12, and at its other end with a second keyway provided in the display disk 26 and with a key that is insertable into the respective keyway, however not illustrated in detail here.

It is possible to realize 10 different switching positions by the first display disk 21 on which the row of numbers 0 to 9 is arranged. For this purpose, the indicator shaft 2 has to sweep across a 36-degrees angle of rotation for each switchover. In 9 out of 10 possible switching positions of the drive wheel 11, the blocking disk 14.2 is then in engagement with the blocking cam 18 of the drive wheel 12 such that only the drive wheel 11, however not the driven wheel 12, accordingly rotates. Only in one possible switching position does the roller component 15 of the Geneva driver 14.1 come into engagement with the engagement components 31 of the Geneva wheel 12.1 during the switchover, that is, during a rotation of the indicator shaft 2 by a defined angle of rotation of preferably 36 degrees, and the roller component 15 entrains the Geneva wheel 12.1 for as long as until the roller component 15 comes out of engagement with the respective engagement component 31. Moreover, the recess in the circle sector of the blocking disk 14.2 comes out of engagement with the blocking cam 18 of the driven wheel 12 during this switchover process such that a transfer of the rotation of the drive wheel 11 to the driven wheel 12 is released. The change of numbers from 9 to 0 as ones digit in the tangential area of the display disks 21 and 26 on the first display disk 21 is therefore assigned to this switchover process, since upon over-sweeping this series of numbers, the tens digit of the tangential area, which tens digit is expressed by the second display disk 26, accordingly also has to change. The switching operations can then also be carried out alternatingly such that it is possible to switch back and forth between two switching positions.

The position indicator 1 is preferably formed as pre-assemblable module and then comprises the first and the second display disk 21 and 26, the plate 9, the first and the second pivot pin 22 and 27, the indicator gear 10, and the base plate 5 that is spaced apart by the spacers 8. Particularly preferentially, the components of the pre-assembled module can also be made from a polymer, to which a glass fiber mixture can also be added according to application. As can be seen in FIG. 2, the pre-assemblable module moreover comprises a blocking device 32 that has two pawls 33 and 34 that are actuatable by a compression spring 35 mounted between the pawls 33 and 34 such that the pawl hooks 36 and 37 that are each provided on a respective one of the pawls 33 and 34, are interlockably bringable into engagement with the gear teeth 17 and 20 of the drive wheel 11 and the driven wheel 12. For this purpose, the pawls 33 and 34 swivel about a common rotational axis 38 when the pre-assembled module is de-installed from the recess of the oil vessel 6. The blocking device 32 for this purpose has bores 39 in the pawls 33 and 34 at the ends located opposite to the pawl hooks 36 and 37, which bores 39 are aligned in an installed state and into which a pin 40 that is fixedly installed in the oil vessel 6, engages and holds the pawls 33 and 34 pressed together essentially parallel in the installed state of the position indicator 1 and only releases the pawls 33 and 34, to be pivotal as described, upon de-installing the position indicator 1. In this manner it is ensured that the switching position does not change when the position indicator 1 is de-installed.

A second embodiment of the position indicator is schematically illustrated in FIG. 3. This second embodiment resembles the first embodiment so that primarily the differences will be explained below. In this embodiment, extensions 41 and 42 are provided between the pivot pins 22 and 27 such that the display disks 21 and 26 can also be mounted outside of the cover of the tap changer.

Reference characters

| | |
|---|---|
| 1 | Position indicator |
| 2 | Indicator shaft |
| 3 | Bushing |
| 4.1 and 4.2 | Fixing components |
| 5 | Base plate |
| 6 | Oil vessel |
| 7.1 and 7.2 | Bores |
| 8 | Spacers |
| 9 | Plate |
| 10 | Indicator gear |
| 11 | Drive wheel |
| 12 | Driven wheel |
| 12.1 | Geneva wheel |
| 13 | Top side |
| 14.1 | Geneva driver |
| 14.2 | Blocking disk |
| 15 | Roller component |
| 16 | Bottom side |
| 17 | Gear teeth |
| 18 | Blocking cam |
| 19 | Bottom side |
| 20 | Gear teeth |
| 21 | First display disk |
| 22 | First pivot pin |
| 26 | Second display disk |
| 27 | Second pivot pin |
| 31 | Engagement components |
| 32 | Blocking device |
| 33 | Pawl |
| 34 | Pawl |
| 35 | Compression spring |
| 36 | Pawl hook |
| 37 | Pawl hook |
| 38 | Rotational axis |
| 39 | Bore |
| 40 | Pin |
| 41 | Extension |
| 42 | Extension |
| 50 | Support arm |
| 51 | Display device |

1. A position indicator for a tap changer of a tapped transformer steppable through switch positions, the position indicator comprising:
a display device for displaying the current switch position of the tap changer, the display device being stepped with each switchover and having first and second display disks; and
an indicator gear coupled to the two display disks for driving them in a switch-direction-dependent manner and couplable to a switching shaft of the tap changer; wherein each display
an angularly extending or circular row of numbers on each display disk oriented such that with each step one number of the row of numbers on the first display disk and one number of the row of numbers on the second display disk are positioned side by side such that these numbers express the current switch position of the tap changer as digits combined to form a multi-digit number.

2. The position indicator according to the previous claim wherein
the indicator gear is formed as a stepping gear and comprises a drive wheel and a driven wheel.

3. The position indicator according to the previous claim wherein
the indicator gear is formed as a Geneva drive;
the drive wheel has a Geneva driver,
the driven wheel is formed as a Geneva wheel that interacts with the Geneva driver.

4. The position indicator according to the previous claim wherein
the drive wheel has a blocking disk;
the driven wheel has a blocking cam that interacts with the blocking disk.

5. The position indicator according to claim 1, wherein
the first display disk is coupled to the drive wheel via a first pivot pin; and/or
the second display disk is coupled to the driven wheel via a second pivot pin.

6. The position indicator according to claim 1, wherein
the row of numbers of the first display disk comprises the numbers 0 to 9; and/or
the row of numbers of the second display disk comprises the numbers 0 to 10.

7. The position indicator according to, claim 1, further comprising:
a base plate on which the display device and the indicator gear are mounted such that the position indicator forms a pre-assembled module that can be detachably installed on an oil vessel of the tap changer.

8. The position indicator according to the previous claim, further comprising:
a blocking device is formed so as to release the indicator gear when the position indicator is installed and block the indicator gear when the position indicator is detached.

9. The position indicator according to the previous claim wherein
the drive wheel has first gear teeth;
the driven wheel has second gear teeth;
the blocking device comprises
a first pawl that interacts with the first gear teeth, can engage into them, and is mounted on the base plate;
a second pawl that interacts with the second gear teeth, can engage into them, and is mounted on the base plate; and
a compression spring braced against the pawls and urges them into the blocked position.

10. The position indicator according to the previous claim wherein
each pawl has a bore;
the bores are aligned with each other in the release position of the blocking device and not aligned with each other in the blocked position of the blocking device;
when the position indicator is installed, the bores are both slipped over a pin on the oil vessel.

11. The position indicator according to claim 1, wherein
individual components of the position indicator are produced using a plastic and/or a polymer and/or a glass-fiber reinforced plastic.

12. The position indicator according to claim 1, further comprising:
extensions between the pivot pins and the respective display disks.
